(19) United States
(12) Patent Application Publication
(10) Pub. No.: US 2005/0224330 A1
(43) Pub. Date: Oct. 13, 2005

(54) Push-button switch with improved movable contact

(75) Inventors: Yan Min Liu, Shenzhen (CN); Wei Yu, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/025,733

(22) Filed: Dec. 28, 2004

(30) Foreign Application Priority Data
Apr. 9, 2004 (TW) 93109868

(51) Int. Cl. H01H 9/26; H01H 13/70

(52) U.S. Cl. 200/345; 200/406; 200/344

(57) ABSTRACT

A push-button switch includes an insulative housing (1), a central fixed contact (412), a pair of side fixed contacts (422), a movable contact (3), an actuator (5) and a cover (2). The cover engages with the housing and defines a guiding hole (210). The central fixed contact and the side fixed contacts are fixed in the housing, of which the side fixed contacts surround the central fixed contact, and each has a pair of fixed contact terminals (411 or 421) extending out the housing. The movable contact is disposed over the fixed contacts. The movable contact has a pair of side contacting portions (35) and a central contacting portion (33). The side contacting portions contact with the side fixed contacts. The central fixed contacting portion is capable of contacting the central fixed contact by resilient deformation. The actuator is disposed on the movable contact and has an operating portion (52) projecting beyond the guiding hole of the cover. The actuator actuates the movable contact to contact the fixed contact.

### BACKGROUND OF THE INVENTION

1. Field of the Invention

The present invention relates to a push-button switch with an improved movable contact, which is widely used in many electronic applications.

2. Description of the Prior Art

A push-button switch using a conventional movable contact is disclosed in U.S. Pat. No. 5,113,047. The conventional push-button switch has a case made of synthetic resin in a form of a box with an opening upper surface. A central stationary contact is exposedly provided at the central of the inner bottom surface of the case, and a pair of stationary contacts is provided on the inner bottom surface surrounding the central stationary. A movable contact held in the case has a dome-shaped configuration in the form of a rectangular sheet, and disposes over the stationary contacts.

The movable contact is made by providing a leaf spring with two slits. The movable contact has a periphery frame interconnecting a central fragment and a pair of side fragments. The central fragment is capable of contacting with the central stationary contact by inverting motions, and the side fragments are bent downwardly along a folding portion, which enable the side fragments contact with the stationary contacts.

When an external force is exerted on the central fragment, the central fragment may be inverted and contact with the central stationary contact. While the force is removed, the converse operation of the central fragment enables itself escaping from contacting with the central stationary contact.

Although the conventional movable contact works well, it has some problems need to be solved. The central fragment directly connects to the periphery frame, thus it can easy acquire a strong operating force. However, the strong operating force may affect the operating-durability of the movable contact. At the same time, the external force is exerted on the central fragment and transmitted through a short C-shaped path to the side fragments. The transmit path is so short that the stress on the movable contact may be very high, which further shortens the lifetime of the movable contact and the lifetime of the push-button switch as well.

Hence, a push-button switch with an improved movable contact is required to overcome the disadvantages of the prior art.

### BRIEF SUMMARY OF THE INVENTION

An main object of the present invention is to provide a push-button switch with an improved movable contact, and the movable contact has a good press-durability.

A push-button switch according to the present invention comprises an insulative housing, a central fixed contact, a pair of side fixed contacts, a movable contact, an actuator and a cover. The cover engages with the housing and defines a guiding hole. The central fixed contact and the side fixed contacts are fixed in the housing, of which the side fixed contacts surround the central fixed contact, and each has a pair of fixed contact terminals extending out the housing. The movable contact is disposed over the fixed contacts. The movable contact has a pair of side contacting portions and a central contacting portion. The side contacting portions contact with the side fixed contacts. The central fixed contacting portion is capable of contacting the central fixed contact by resilient deformation. The actuator is disposed on the movable contact and has an operating portion projecting beyond the guiding hole of the cover. The actuator actuates the movable contact to contact the fixed contact.

The movable contact has a periphery frame, an inner frame and an interconnecting portion interconnecting the periphery frame and the inner frame. The side contacting portions are defined at opposite edges in the periphery frame by bent down folding portions thereof, and the central contacting portion is defined in the inner frame by providing a pair of inner slits parallelly defined along. A periphery slits is defined in the periphery frame between each interconnecting portion and the corresponding side contacting portion. A pair of opposite C-shaped slits is defined between the inner frame and the periphery frame in a longitudinal direction.

To compare with the conventional push-button switch, the present invention comprises the improved movable contact. The movable contact has the periphery frame, the inner frame and the pair of interconnecting portions interconnecting the periphery frame and the inner frame. The central contacting portion is connected to the inner frame. In operation, an external force is exerted on the central contacting portion. Then the force is transmitted to the interconnecting portion through a C-shaped path, and transmitted from the interconnecting portion to the side contacting portions through a second C-shaped path. As the force transmit path is obviously prolonged, the stress of the movable contact can be lowed down, which ensures a reliable press-durability of the movable contact.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a push-button switch corresponding to the present invention;

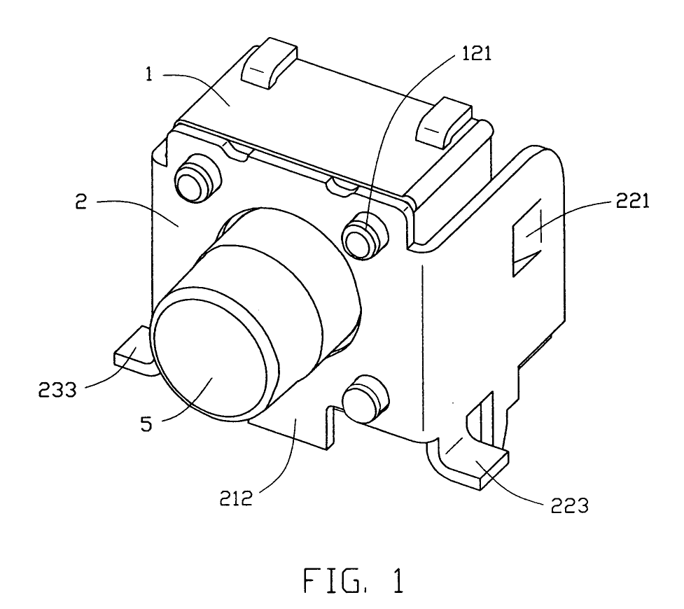

FIG. 2 is an exploded view of the push-button switch in FIG. 1;

FIG. 3 is another exploded view of FIG. 1;

FIG. 4 is a perspective view of a movable contact of the push-button switch; and

FIG. 5 is a sectional view of the push-button switch in FIG. 1.

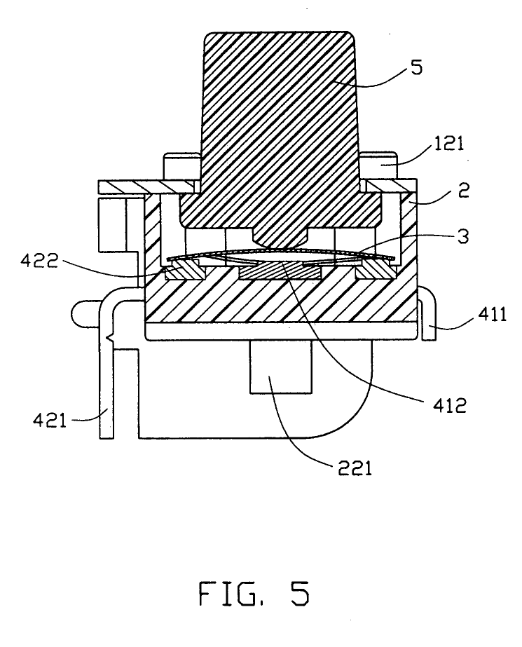

### DETAILED DESCRIPTION OF THE INVENTION

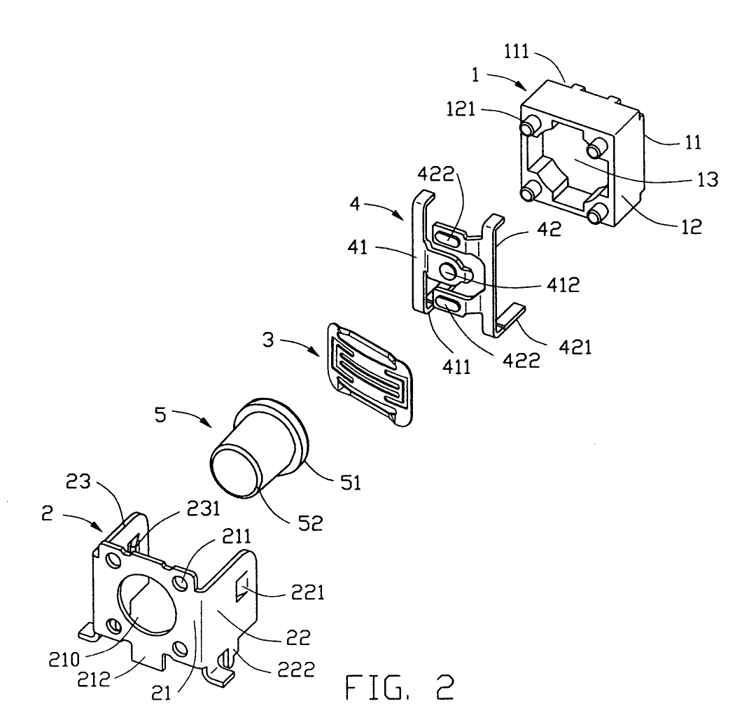

Referring to FIG. 2, a push-button switch in accordance with the present invention comprises an insulative housing 1, a plurality of fixed contacts 4, a movable contact 3, an actuator 5 and a cover 2.

The insulative housing 1 is a synthetic resin mold in a form of a case with a base 11 opening to the air. The base 11 has a periphery wall 12 extending upwardly therefrom, and a cavity 13 is defined and enclosed by the periphery wall 12. The periphery wall 12 forms a plurality of positioning posts 121 on corner portions of an upper surface thereof. The base 11 has a plurality of recesses 111 defined on corner portions of a lower surface thereof.

The plurality of fixed contacts 4 are fixed in the housing 1 by insert molding. The plurality of fixed contacts 4 comprises a central fixed contact strip 41 and a side fixed contact strip 42, which are parallel each other. The central fixed contact strip 41 has a central fixed contact 412 laterally extending from a central portion thereof. The side fixed contact strip 42 has a pair of side fixed contacts 422 laterally extending therefrom, wherein the side fixed contacts 422 surrounds the central fixed contact 412. A plurality of fixed contact terminals 411 and 421 is respectively extended out of the housing from ends of the central fixed contact strip 41 and the side fixed contact strip 42.

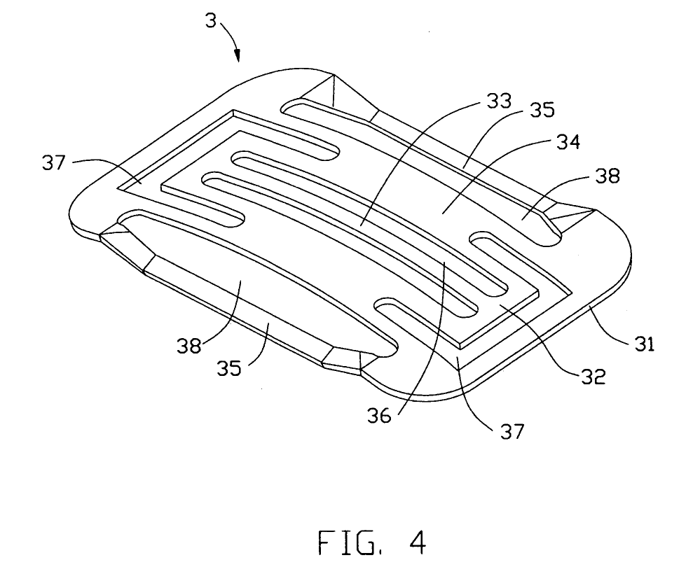

Also referring to FIG. 4, the movable contact 3 made of conductive and resilient material has a rectangular dome-shaped configuration. The movable contact 3 has a periphery frame 31, an inner frame 32 and an interconnecting portion 34 interconnecting the periphery frame 31 and the inner frame 32. A pair of opposite C-shaped slits 37 is defined between the inner frame 32 and the periphery frame 31 in a longitudinal direction. The periphery frame 31 has a pair of side contacting portions 35 located at opposite edges by bent down folding portions for contacting the side fixed contacts 422. A periphery slit 38 is defined between each interconnecting portion 34 and the corresponding side contacting portion 35. A central contacting portion 33 is formed by providing a pair of inner slits 36 parallelly defined along in the inner frame 32.

The actuator 5 comprises a holding portion 51. The holding portion 51 has a columnar configuration. An operating portion 52 is extended upwardly from the holding portion 51, which is also columnar but smaller than the holding portion 51 in diameters. The holding portion 51 has a concave defined at a lower surface thereof. A pressing portion 511 is projected beyond the lower surface of the holding portion 51 from the concave. The pressing portion 511 has a plurality of radicalized portion interconnecting the pressing portion 511 and the holding portion 51.

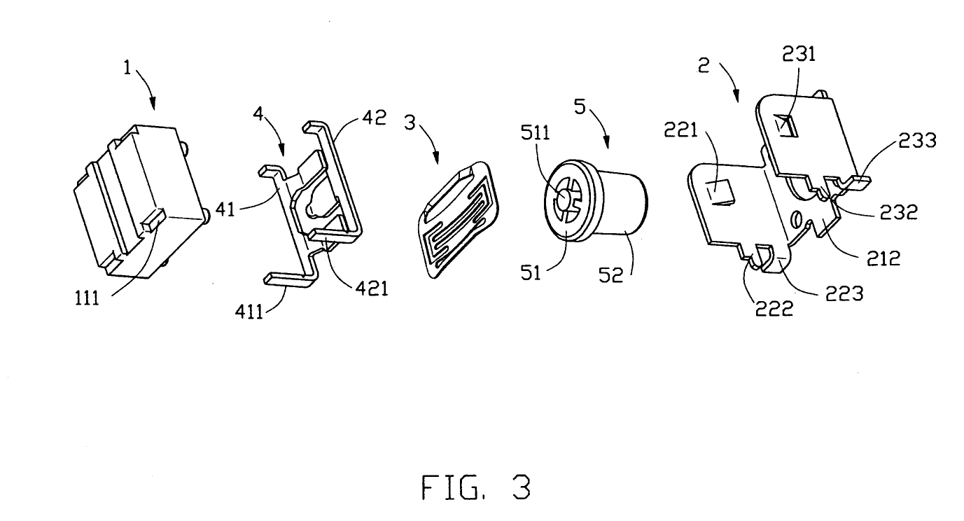

The cover 2 engages with the housing 1, and has a front wall 21 and opposite right and left walls 22 and 23. The opposite right and left walls 22 and 23 are respectively extended rearward from right and left edges of the front wall 21. The front wall 21 has a guiding hole 210 defined at a central portion thereof corresponding to the operating portion 52. Corresponding to the positioning posts 121 formed on the upper surface of the periphery wall 12, the front wall 21 also defines a plurality of the positioning holes 211 at corner portions thereof. A placing tab 212 is extended from a central portion of a lower edge of the front wall 21. A holding tab 221 or 231 is formed at the right or left wall 22 or 23, which is substantially formed by bending a tab partially cut from the right or left wall 22 or 23. The placing tabs 222 and 232 (best shown in FIG. 3) are extended from lower edges of the right and left walls 22 and 23.

In assembly, the fixed contacts 4 are mounted in the housing 1 by insert molding. The central fixed contact strip 41 and the side fixed contact strip 42 are mounted parallel each other, the side fixed contact 422 surrounds the central fixed contact 412, and the fixed contact terminals 411 and 421 extend out of the housing 1. The movable contact 3 is received in the cavity 13 of the housing 1. The side contacting portions 35 contact with the corresponding side fixed contacts 422. The central contacting portion 33 is correspondingly disposed over the central fixed contact 412 for contacting with it in inverting operation. The actuator 5 is mounted on the movable contact 3, of which the pressing portion 511 is disposed on the central contacting portion 33. The cover 2 engages with the housing 1, of which the positioning holes 211 couples with the positioning posts 121, the operating portion 52 extends beyond the guiding hole 210, and the holding tabs 221 and 231 holds the lower surface of the base 11.

In operation, an external force is exerted on the operating portion 52, the central contacting portion 33 may be inverted to contact with the central fixed contact 412, and an electrical connection between the fixed contact terminals 411 and 421 is established. When the external force is removed, the recover force of the movable contact 3 enables the actuator 5 return to a normal status, and the electrical connection is eliminated.

The structure of the movable contact 4 is the merit of the improvement of the present invention. When the central contacting portion 33 is pressed, the force is transmitted to the interconnecting portion 34 through a C-shaped path, and then transmitted from the interconnecting portion 34 to the side contacting portions 35 through a second C-shaped path. As the force transmit path is very long, the stress of the movable contact 4 can be lowed down, which ensures a reliable press-durability of the movable contact 4. Though the recover force of the movable contact 4 may also be lowed down, adjusting the curvature of the movable contact 4 may solve this problem.

It will be understood that the invention may be embodied in other specific forms without departing from the spirit or central characteristics thereof. The present examples and embodiments, therefore, are to be considered in all respects as illustrative and not restrictive, and the invention is not be limited to the details given herein.

1. A push-button switch comprising:
an insulative housing having a base;
a cover engaging with the housing and defining a guiding hole;
a central fixed contact strip fixed in the housing and having terminals extending out the housing;
a side fixed contact strip fixed in the housing and including a pair of side fixed contacts and a pair of terminals extending out the housing, the side fixed contacts surrounding the central fixed contact;
a movable contact received in the housing and disposed over the fixed contacts, and having a pair of side contacting portions correspondingly contacting with side fixed contacts and a central contacting portion capable of contacting the central fixed contact by resilient deformation;
an actuator received in the housing, being disposed on the movable contact and having an operating portion projecting beyond the guiding hole of the cover, actuating the movable contact to contact the fixed contact; and
wherein the movable contact has an interconnecting portion and a plurality of slits to alleviate the stress.

2. The push-button switch as claimed in claim 1, wherein the movable contact has a periphery frame, an inner frame and an interconnecting portion interconnecting the periphery frame and the inner frame.

3. The push-button switch as claimed in claim 2, wherein the side contacting portions are defined at opposite edges of the periphery frame by bending down folding portions thereof, and the central contacting portion is defined in the inner frame by providing a pair of inner slits parallelly defined along.

4. The push-button switch as claimed in claim 3, wherein a periphery slit is defined in the periphery frame between the interconnecting portion and a corresponding side contacting portion.

5. The push-button switch as claimed in claim 2, wherein a pair of opposite C-shaped slits is defined between the inner frame and the periphery frame in a longitudinal direction.

6. The push-button switch as claimed in claim 1, wherein the housing has a plurality of positioning posts, the cover defines a plurality of positioning holes, and the positioning posts couple with the positioning holes.

7. A push-button switch comprising:
an insulative housing defining a center portion and a periphery portion;
a first fixed contact set located in said center portion;
a second fixed contact set located in said periphery portion;
a moveable contact located above said first and second fixed contact sets, and including an immoveable outer frame constantly engaged with the second fixed contact set, and a moveable inner frame located right above the first fixed contact set, said inner frame being initially upwardly symmetrically curved along a first direction while being adapted to be downwardly symmetrically curved when a downward force is applied thereon so as to be mechanically and electrically engaged the first fixed contact set thereunder, wherein
said inner frame is not directly linked to the outer frame in said first direction but via a downwardly deflectable interconnecting portion which is directly linked to the outer frame in said first direction.

8. The push-button switch as claimed in claim 7, wherein said inner frame is linked to the interconnecting portion in a second direction transverse to said first direction.

9. The push-button switch as claimed in claim 7, wherein both said inner frame and said outer frame are rectangular.

10. A contact arrangement for use within a switch, comprising:
a first fixed contact set located in a center portion;
a second fixed contact set located in a periphery portion surrounding said center portion;
a moveable contact located above said first and second fixed contact sets, and including an immoveable outer frame constantly engaged with the second fixed contact set, and a moveable inner frame located right above the first fixed contact set,
said inner frame being not directly linked to the outer frame but via a downwardly deflectable interconnecting portion which is not located right above the first fixed contact set while being directly linked to the outer frame;
wherein
both said interconnecting portion and said inner frame are upwardly bowed in a relaxed manner while both being downwardly deformably bowed in a stressed manner to have the inner frame mechanically and electrically engage the first fixed contact when a downward force is imposed upon the inner frame.
